(19) United States
(12) Patent Application Publication
(10) Pub. No.: US 2007/0034299 A1
(43) Pub. Date: Feb. 15, 2007

(54) Rare earth - iron - bron based magnet and method for production thereof

(75) Inventors: Kenichi Machida, Osaka (JP); Shunji Suzuki, Shizuoka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: JAPAN SCIENCE AND TECHNOLOGY AGENCY, Saitama (JP); MACHIDA, KENICHI, Osaka (JP)

(21) Appl. No.: 10/560,831

(22) PCT Filed: Jun. 14, 2004
(86) PCT No.: PCT/JP04/08312

§ 371 Date: Nov. 1, 2006

(30) Foreign Application Priority Data
Jun. 18, 2003 (JP) 2003-174003

(51) Int. Cl. H01F 1/057

(52) U.S. Cl. 148/105; 148/302

(57) ABSTRACT

[Object] To provide a high-performance rare earth-based magnet exhibiting a high coercive force or a high residual magnetic flux density even when the content of a rare earth element such as Dy or the like which is scarce is reduced.

[Construction] A rare earth-iron-boron based magnet includes a crystal grain boundary layer enriched in element M (M is at least one rare earth element selected from Pr, Dy, Tb, and Ho) by diffusion of the element M from the surface of the magnet, wherein the relation between the coercive force H_{cj} and the content of the element M in the whole of the magnet is represented by the following expression: H_{cj}≧1+0.2×M (wherein 0.05≦M≦10) wherein H_{cj} is the coercive force (unit: MA/m), and M is the content of the element M in the whole of the magnet (% by mass). Furthermore, the magnet satisfies the following expression: Br≧1.68−0.17×H_{cj} wherein Br is the residual magnetic flux density (unit: T).

### TECHNICAL FIELD

The present invention relates to a rare earth-iron-boron based magnet such as a Nd—Fe—B or Pr—Fe—B based magnet, and particularly to a high-performance magnet effectively utilizing a scarce metal, such as Dy or the like, and a method for production thereof.

### BACKGROUND ART

Rare earth-iron-boron based magnets, particularly Nd—Fe—B based sintered magnets, are known as highest-performance magnets among permanent magnets and are widely used for voice coil motors (VCM) of hard disk drives, magnetic circuits of magnetic tomographic apparatuses (MRI), and the like. As magnets for these applications, magnets having a high residual flux density Br and a high maximum energy product (BH)ₘₐₓ among magnetic properties are suitable, and coercive force H_{cj} may be low.

On the other hand, heat resistance has been recently required for applications to electromobiles, and magnets having a high coercive force have been required for avoiding high-temperature demagnetization at 100° C. to 200° C. Therefore, in recent years, there have been increasingly used sintered magnets in each of which the structures of a Nd₂Fe₁₄B main phase and a Nd-rich peripheral sub-phase are optimally controlled, and several to tens % by mass of element Dy which is a scarcer resource than element Nd is added to the magnet to increase the coercive force.

However, such a magnet has a conflicting relationship between Br or (BH)ₘₐₓ and H_{cj}. When the amount of element Dy added to a magnet is increased to increase H_{cj}, the saturation magnetic flux density of the magnet is rapidly decreased to decrease Br and (BH)ₘₐₓ. Therefore, there has not yet been proposed a rare earth-based magnet having high values of both Br or (BH)ₘₐₓ and H_{cj}, and magnet products are classified into a high-performance (high Br) type and a heat-resistant (high H_{cj}) type.

In order to improve H_{cj} of a Nd—Fe—B based magnet while suppressing a decrease in Br, there have been many reports of improvements in the sintering density and orientation of crystal grains, the selection of appropriate sintering conditions and an element to be added for refining a crystal structure, etc. It has also been known that a sintered magnet has a nucleation-type coercive force mechanism. Therefore, it is desirable to clean crystal grain boundaries and the magnet surface which easily serve as generation sources of a reverse magnetic domain, for magnetically strengthening the magnet. For this purpose, it is effective to preferentially add Dy, Tb, or the like having higher magnetic anisotropy than that of Nd to grain boundaries in a magnet alloy.

An example of known inventions relating to a method for improving a coercive force is a method in which in producing a sintered magnet, an alloy mainly composed of Nd₂Fe₁₄B and a Dy-rich alloy or an alloy with a composition slightly different from the composition Nd₂Fe₁₄B are separately produced, the powders of these alloys are mixed at an appropriate ratio, and the resulting mixture is molded and then sintered to improve the coercive force (for example, Patent Documents 1 and 2). Another example is a method in which in producing an anisotropic magnet powder, an alloy powder mainly composed of Nd₂Fe₁₄B and a Dy alloy powder are mixed and heat-treated to coat the surfaces of the Nd₂Fe₁₄B alloy powder with Dy, thereby increasing the coercive force (for example, Patent Document 3).

On the other hand, when a sintered magnet is actually used for a motor or the like, the final dimensions and concentricity are actually achieved by grinding. However, a Nd-rich phase in a surface layer of the magnet is damaged by micro grinding cracks and oxidation, and consequently, the magnetic properties of the magnet surface are degraded to a few fractions of those of the inside of the magnet. This phenomenon is particularly significant in a micro magnet having a high surface area ratio to the volume.

As a method for improving the above-described detect of an Nd—Fe—B sintered magnet, it has been proposed that a layer damaged by machining is removed by mechanical polishing or chemical polishing (for example, Patent Document 4). Another proposed method is to deposit a rare earth metal on the surface of a magnet subjected to polishing, followed by diffusion heat treatment (for example, Patent Documents 5 and 6). Furthermore, there has been found a method of forming an SmCo film on the surface of an Nd—Fe—B based magnet (for example, Patent Document 7).

Patent Document 1: Japanese Unexamined Patent Application Publication No. 61-207546

Patent Document 2: Japanese Unexamined Patent Application Publication No. 5-021218

Patent Document 3: Japanese Unexamined Patent Application Publication No. 2000-96102

Patent Document 4: Japanese Unexamined Patent Application Publication No. 9-270310

Patent Document 5: Japanese Unexamined Patent Application Publication No. 62-74048 (Japanese Examined Patent Application Publication No. 6-63086)

Patent Document 6: Japanese Unexamined Patent Application Publication No. 1-117303

Patent Document 7: Japanese Unexamined Patent Application Publication No. 2001-93715

### DISCLOSURE OF INVENTION

### Problems to be Solved by the Invention

Patent Documents 1 and 2 disclose that two alloys are used as starting raw materials, and element Dy or the like is distributed in a Nd-rich grain boundary phase in a larger amount than in a Nd₂F₁₄B main phase, thereby obtaining a sintered magnet in which the coercive force is improved while suppressing a decrease in the residual magnetic flux density. At present, this technique is partially applied to production of a magnet.

However, the technique has may production problems to be resolved, such as the problem of requiring a number of steps for producing an alloy rich in Dy or the like, the problem of requiring a special method, such as a rapid quenching method or hydrogen embrittlement, for grinding the alloy to several microns because the alloy is tough, the problem of requiring a high antioxidation property because the alloy is significantly easily oxidized as compared with a Nd₂Fe₁₄B composition alloy, the problem of requiring strict control of sintering of the two alloys and the heat treatment reaction, and the like. Magnets currently produced by this method still contain less than 10% by mass of Dy, and thus high-coercive force magnets have a low residual magnetic flux density.

Patent Document 3 discloses that a Nd—Fe—B based magnet powder and a powder of Dy—Co, TbH₂, or the like are mixed, and the resultant mixture is heat-treated at a high temperature to coat the magnet powder surfaces with Dy or Tb, thereby obtaining an anisotropic magnet powder having a high coercive force. However, the problems of grinding and oxidation of the powder of Dy—Co, TbH₂, or the like cannot be resolved by this method, and it is difficult to consume the powder of Dy—Co, TbH₂, or the like by complete reaction and obtain only the magnet powder used as a base. Also, in an anisotropic magnet, a clear grain boundary phase is not recognized because the crystal grain size is about 0.3 micron, and the coercive force mechanism is different from that in a sintered magnet. It is thus unknown how Dy coating contributes to improvement in the coercive force.

It has also been known that an Nd—Fe—B based magnet produces oxidation and mechanical deterioration during the process for obtaining the magnet having the final dimensions. Although the technique disclosed in Patent Documents 1 and 2 improves a crystal structure which constitutes the inside of a sintered magnet, characteristics are inevitably degraded by cutting and polishing for producing a general magnet product. Similarly, in the method disclosed in Patent Document 3, when a mixture of an improved magnet powder and an epoxy resin or the like is molded under a pressure of several hundreds MPa, many powders are crushed by compression in the process, thereby degrading the magnetic properties. As a result, the resultant bonded magnet has lower performance than that inherent to the magnet powder used.

The internal structure of a sintered magnet includes a homogeneous main phase containing fine crystal grains having a grain size of 6 to 10 microns and an Nd-rich homogenous grain boundary phase surrounding the main phase and having a thickness of 1 micron or less. In a nucleation-type magnet, the magnitude of coercive force is determined by how to suppress the occurrence of a reverse magnetic domain in the demagnetizing field applied. It is thus necessary to remove impurities and an inhomogeneous structure which easily serve as nuclei of a reverse magnetic domain. For example, the document, D. Givord et al., J. Appl. Phys., 60 (1986), 3263 indicates that a reverse magnetic domain occurs due to a disturbance in crystal grain boundaries in a magnet and oxidation and mechanical damages in the surface of the magnet, and particularly, the reverse magnetic domain is greatly affected by the magnet surface. Also, it is well known that when a sintered magnet is cut into a magnet having a thickness of about 1 mm or less by machining, the coercive force is significantly decreased.

Accordingly, an object of the present invention is to provide a high-performance rare earth-based magnet exhibiting a high coercive force or a high residual magnetic flux density even when the content of a rare earth element such as Dy or the like, which is scarce, is reduced.

### Means for Solving the Problems

A rational method for improving the magnetic properties of a sintered magnet is to apply a technique for improving the properties to the magnet after machining for obtaining a final product having predetermined shape dimensions. The inventors of the present invention filed patent application for an invention relating to a technique for improving the magnetic properties by depositing a rare earth metal on the surface of a final magnet product and diffusing the rare earth metal (Patent Application No. 2003-96866).

As a result of detailed investigation of the contents of the technique, the inventors found a method for realizing a coercive force, which has not been achieved by a conventional sintered magnet, using a small mount of Dy or the like or for improving the residual magnetic flux density at a Dy content equivalent to that of a conventional magnet. This method is capable of significantly improving the maximum energy product by suppressing a decrease in the residual magnetic flux density.

As a result of detailed experiment and research on the crystal structure of a sintered magnet and the function of an element such as Dy or the like contained in the magnet on the basis of the coercive force mechanism of an Nd—Fe—B rare earth-based magnet, the inventors succeeded in developing a high-performance rare earth-based magnet in which a rare earth metal such as Dy or the like is thinly distributed inside the magnet and thickly distributed on the surface side, thereby effectively utilizing the rare earth metal such as Dy or the like in the magnet.

(1) The present invention relates to a rare earth-iron-boron based magnet including a crystal grain boundary layer which is enriched in element M (M is at least one rare earth element selected from Pr, Dy, Tb, and Ho) by diffusion from the surface of the magnet, the coercive force H_{cj} and the content of the element M in the whole of the magnet satisfying the following equation:
H_{cj}≧1+0.2×M (wherein 0.05≦M≦10)
wherein H_{cj} is the coercive force (unit: MA/m), and M is the content of the element M in the whole of the magnet (% by mass).

(2) The present invention also relates to the rare earth-iron-boron based magnet described in (1) in which the residual magnetic flux density Br and the coercive force H satisfy the following equation:
Br≧1.68−0.17×H_{cj}
wherein Br is the residual magnetic flux density (unit: T)

(3) The present invention also relates to the rare earth-iron-boron based magnet described in (1) or (2), which is produced by powder molding and sintering or by powder molding and hot plastic processing, the magnet including a rare earth-rich grain boundary layer disposed between main crystals.

(4) The present invention further relates to a method for producing the rare earth-iron-boron based magnet described in any one of (1) to (3), the method including physically spraying a vapor or fine particles of element M (M is at least one rare earth element selected from Pr, Dy, Tb, and Ho) or an alloy containing the element M onto the entire surface or a portion of the surface of a magnet supported in a reduced-pressure vessel to deposit a film of the element M, and diffusing and penetrating the element M into the magnet from the surface thereof so that the element M reaches at least a depth corresponding to the radius of the crystal grains exposed at the surface of the magnet, thereby forming a crystal grain boundary layer enriched in the element M.

(5) The present invention further relates to the method for producing the rare each-iron-boron based magnet descried in (4), in which the crystal grain boundary layer is enriched in the element M so that the concentration of the element M increases toward the surface side of the magnet.

In the present invention, the element M (M is at least one rare earth element selected from Pr, Dy, Tb, and Ho) is deposited on the surface of the magnet and diffused to enrich the crystal grain boundary layer in the element M so that the rare earth metal is thinly distributed on the inner side and thickly distributed on the surface side.

In order to achieve a high coercive force in an Nd—Fe—B sintered magnet having, it is particularly effective to use a rare earth element having a high anisotropic magnetic field as an element to be contained, and to control the internal structure of the magnet to a homogeneous fine structure. In an R₂Fe₁₄B compound in which R is a rare earth element, Pr, Dy, Tb, or Ho has a higher anisotropic magnetic field than that of Nd at room temperature. In particular, the anisotropic magnetic field of Tb is about 3 times that of Nd, and thus Tb is suitable for improving the coercive force.

However, any one of these elements has lower saturation magnetization than that of Nd, and thus the amount of the element added must be decreased as much as possible for securing a desired energy product. Furthermore, when element Nd in an Nd₂Fe₁₄B main phase in a crystal structure is replaced by such an element, the magnetic flux density is significantly decreased. Therefore, it is desirable that such an element is present in an Nd-rich grain boundary layer, not in the crystal structure.

FIG. 1 shows a Dy element EPMA image (a) of an Nd—Fe—B based sintered magnet produced by depositing metal Dy and then heat-diffusing the element, i.e., a sample (3) of the present invention, and a Dy element EPMA image (b) of a comparative example sample (1) produced by a conventional method using an alloy containing a predetermined amount of Dy as a starting material.

The image (a) of the sample (3) of the present invention indicates that the element Dy is thickly distributed in a surface portion (or near the surface) of the magnet and diffused and penetrated inward to a depth of about 30 to 40 μm along crystal grain boundaries. It is also found that substantially no element Dy is observed in the crystal structure, and the element Dy is preferentially diffused in the crystal grain boundaries. The higher coercive force than that of the comparative example sample (1) at the same Dy content is evidenced by the structure of a crystal grain boundary layer of the magnet in which the concentration of the element Dy increases toward the surface side.

On the other hand, the image (b) of the comparative example sample (1) indicates that the concentration of the element Dy locally varies in the magnet, but the element Dy is averagely distributed over the whole. Also, FIG. 1(a) shows that the crystal grains in the first surface layer of the magnet remain after diffusion of the element Dy, and the grains in the second layer are also not greatly changed in the form as magnet grains. In each of FIGS. 1(a) and 1(b), a layer of several microns on the upper surface side of the magnet is formed by polishing droop of the magnet sample.

The magnet of the present invention exhibits excellent magnetic properties as compared with a conventional sintered magnet. In the magnet of the present invention, the relation between the content of the element M (M is at least one rare earth element selected from Pr, Dy, Tb, and Ho) and coercive force H_{cj} is represented by the expression, H_{cj}≧1+0.2×M (wherein 0.05≦M≦10) wherein H_{cj} is coercive force (unit, MA/m), and M is the content (% by mass) of the element M in the whole magnet. Also, the relation between the residual magnetic flux density Br and coercive force H is represented by the expression, Br≧1.68−0.17×H_{cj} wherein Br is the residual magnetic flux density (unit, T).

When the element M remains in the outermost layer after diffusion or the original magnet contains the element M, the content of the element M in the whole magnet includes the content of the element M remaining in the surface layer or the element M contained in the original magnet. Therefore, it is said to be preferable that the content of the element M contained in the original magnet is decreased, and the deposited element M is diffused as much as possible.

FIG. 2 shows the relations between the coercive force and the Dy content examined for examples of the magnet of the present invention and conventional magnets (commercial product; NEOMAX magnet manufactured by Sumitomo Special Metals Co., Ltd.). FIG. 3 shows the relations between the residual magnetic flux density and coercive force. Since the values of magnetic properties are affected by a magnetizing magnetic field, magnetization is ideally performed in at least the anisotropic magnetic field of a magnet to be measured. However, the measurement was carried out after pulse magnetization of 4 MA/m.

FIG. 2 indicates that the magnet of the present invention has a high coercive force over the entire region of Dy contents as compared with the conventional magnets. The degree of the effect is found by the fact that the magnet of the present invention sufficiently satisfies the relational expression H_{cj}≧1+0.2×M. Similarly, FIG. 3 shows that the magnet of the present invention has a high residual magnetic flux density and high coercive force as compared with the conventional magnets A and B, and satisfies the relational expression Br≧1.68−0.17×H_{cj}. Therefore, the energy product is inevitably improved.

According to the present invention, as described above, the element M is distributed so that the concentration of the element M increases toward a portion immediately below the magnet surface and the surface side of a crystal grain boundary continued from the portion. Therefore, the coercive force is increased, as compared with a conventional magnet, or the residual magnetic flux density is improved at an element M content equivalent to that of a conventional magnet. As a result, the content of the rare earth element such as Dy or the like, which is scarce, in the magnet can be reduced.

### ADVANTAGES OF THE INVENTION

According to the present invention, a rare earth metal such as Dy, Tb, or the like is deposited on the surface of a rare earth-based magnet and then diffused so that the concentration of the rare earth metal on the surface side is higher than that inside the magnet. Therefore, a high coercive force can be exhibited at a rare earth metal content lower than that of a conventional magnet or the residual magnetic flux density can be improved at a Dy content equivalent to that of a conventional magnet. As a result, the present invention contributes to improvement in the energy product of the magnet and the resolution of the problem with scarce resources such as Dy and the like.

### BEST MODE FOR CARRYING OUT THE INVENTION

When element M is deposited in a film on the surface of a sintered magnet and then heat-treated, the element M is mostly diffused into crystal grain boundaries in the sintered magnet, into which the element is easily penetrated, and slightly diffused into main crystals. The diffusion depth of the element M is 3 microns to 1000 microns, and the diffusion region includes an M-Nd—Fe—O component phase formed in each crystal grain boundary layer into which the element M is mainly diffused, and an Nd—Fe—B-M component phase formed in each main crystal into which the element M is partially diffused. The thickness of the crystal grain boundary layers is several tens nanometers to 1 micron.

The formation of the crystal gain boundary layers containing a large amount of element M increases the coercive force. Even a conventional Nd—Fe—B sintered magnet contains main crystal grains (Nd—Fe—B) and crystal grain boundary layers (several to several hundreds nanometers in thickness, mainly composed of Nd, Fe, and O, and referred to as “Nd-rich phases”). When a magnet contains a small amount of element M added thereto a raw material, all grain boundary layers of the magnet are uniformly enriched in the element M. However, the grain boundaries are mainly composed of Nd, and the main crystals are not completely surrounded by the grain boundary layers. For these reasons, a high coercive force cannot be achieved.

In the present invention, it is supposed that the coercive force is significantly improved by the following fact: In a sintered magnet or a magnet produced by molding a raw material powder and then processing the molded product by hot plastic working, the element M is mainly present in the Nd-rich grain boundary thin layers between the crystal grains which are originally present in the magnet, and the crystal grain boundary layers are formed to a thickness sufficient to completely surround the main crystals.

The rare earth-iron-boron based magnet of the present invention and a method for producing the same will be described in detail below. The values of the magnetic properties of the magnet of the present invention are affected by the composition of the magnet, the production method therefor, the volume of the magnet, the type of the element M, and the like. However, production under proper conditions can produce a well-balanced magnet exhibiting a high coercive force and a high residual magnetic flux density.

The method of the present invention is aimed at a sintered magnet produced by grinding a raw material alloy to several microns, molding the powdered alloy, and then sintering the molded product, or a magnet produced by molding a raw material powder and then processing the molded product by hot plastic working, the magnet containing crystal grain boundary layers and being machined to predetermined dimensions for obtaining a final product. In particular, the present invention has a significant effect on an Nd—Fe—B sintered magnet because it shows a typical nucleation-type coercive force mechanism.

In the present invention, the effect becomes significant as the volume of the rare earth-based magnet decreases and the surface area ratio to the volume increases. This is because the magnet of the present invention uses diffusion of the rare earth metal from the surface thereof, and thus improvements of the magnetic properties are affected by the size of the magnet. Namely, in comparison to a conventional magnet, a high coercive force is easily obtained by a magnet having a smaller volume. Therefore, an intended magnet of the present invention preferably has a thickness of 10 mm or less and more preferably 2 mm or less regardless of whether the shape of the magnet is a plate-like or cylindrical shape.

As the metal supplied and deposited or deposited in a film on the surface of the magnet, at least one element M selected from the rare earth metals such as Pr, Dy, Tb, and Ho, or an alloy or a compound containing a great amount of the element M, for example, a Tb—Fe alloy, a Dy—Co alloy, TbH₂, or the like, can be used for easily diffusing the element M having higher magnetic anisotropy than that of Nd into the Nd-rich grain boundary phases and the like which constitute the magnet.

When the surface of the magnet is simply coated with the element M, improvements of the magnetic properties are not observed. Therefore, it is necessary that at least a portion of the deposited metal component is diffused into the magnet to form the crystal grin boundary layers in each of which the element M reacts with a phase rich in a rare earth metal such as Nd or the like which is a constituent element of the magnet.

Therefore, after deposition, the deposited metal is generally diffused by heat treatment at 500° C. to 1000° C. In sputtering, the magnet may be heated together with a holding tool or RF or DC power of sputtering deposition may be increased to heat the magnet to the above-described temperature range, for example, 800° C., during the deposition, thereby permitting diffusion substantially at the same time as the deposition.

In addition, in order to increase the coercive force, it is effective that the penetration depth of the element M which is penetrated by thermal diffusion treatment is at least the radius of the crystal grains exposed at the surface of the magnet. For example, the crystal grain size of an Nd—Fe—B sintered magnet is about 6 to 10 μm, and thus the necessary lower limit of the penetration depth is 3 μm or more equivalent to the radius of the crystal grains exposed at the surface of the magnet. With a penetration depth less than this, reaction with the Nd-rich grain boundary phase surrounding main crystal grains becomes insufficient, and thus the coercive force is little improved. With a penetration depth of 3 μm or more, the coercive force is significantly improved. However, an excessive penetration depth increases the probability of replacement with Nd in the main phases, thereby decreasing residual magnetization. Therefore, diffusion conditions are preferably controlled so as to obtain the desired magnetic properties.

As a result, for example, the concentration of the element M in the surface layer of the magnet is about 100% by mass, the concentration of the element M in the crystal grain boundary layers into which the element M is diffused is several tens % by mass (increasing toward the surface of the magnet), and the concentration of the element M in averaged regions (for example, several tens microns) of the main phases and the grain boundary layers into which the element M is diffused is several % by mass. Although the crystal grain boundary layers of the original magnet are generally several to several hundreds nanometers in thickness, the thickness of the crystal grain boundary layers is increased to several tens nanometers to 1 micron by diffusion enrichment of the element M. Therefore, the concentration of the element M in the rare earth-rich crystal grain boundary layers enriched in the element M is about 50% by mass or more, preferably 70% by mass or more, and more preferably 90% by mass or more, for example, at a depth of 10 microns from the surface.

The element M is penetrated into the magnet by heat treatment, but Nd and Fe elements present in the surface of the original magnet are partially mixed in the deposited film of the element M by mutual diffusion. However, the amount of such reaction in the film of the element M is small, and thus there is substantially no adverse effect on the characteristics of the magnet. Although a portion of the film may not be diffused and remain on the surface of the magnet after diffusion treatment, the element M is preferably completely diffused for saving the element M and obtaining a satisfactory effect.

The thickness of the element M film is 0.02 μm to 50 μm and preferably 0.5 μm to 20 μm, and the depth of distribution in which the element M is diffused and penetrated into the magnet from the surface, i.e., the thickness of the diffusion layer, is 3 μm to 1000 μm and preferably 10 μm to 200 μm. These ranges must be inevitably narrowed as the magnet size decreases, and when the coercive force is desired to be increased, the thickness of the deposited film is increased to increase the diffusion depth.

For example, in a small magnet having a thickness of 1 mm or less, even when the thickness of the deposited film is about 0.02 μm, the effect of increasing the coercive force by diffusion is exhibited. As the thickness of the deposited film increases, the content of the element M contained over the whole of the magnet by diffusion increases, and the coercive force also increases. However, when the thickness is about 50 μm or more, the content of the element M, which is a nonmagnetic element, increases, and a decrease in the residual magnetic flux density over the whole of the magnet increases. Therefore, it is necessary to control the thickness of the deposited film and diffusion conditions in consideration of the desired coercive force and residual magnetic flux density.

The content of the element M in the whole magnet is 0.05% by mass to 10% by mass. At a content of less than 0.05% by mass, the amount of the element M to be supplied to the surface of the magnet and diffused is excessively small, and thus the effect of improving the coercive force little exhibited. At a content of over 10% by mass, the residual magnetic flux density is significantly decreased, and thus the maximum energy product is also significantly decreased, thereby failing to obtain the magnetic properties inherent to the rare earth-based magnet. When the content is 10% by mass, H_{cj} is 3 MA/m or more, and the magnet can be satisfactorily used for heat-resistant automobile applications.

The method for supplying the rare earth metal M to the surface of the magnet is not particularly limited, and a physical deposition method such as evaporation, sputtering, ion plating, laser deposition, or the like, a chemical vapor deposition method such as CVD or MO-CVD, or a plating method may be used. However, each of the treatments such as the deposition and subsequent thermal diffusion is preferably performed in a clean atmosphere containing several tens ppm or less of oxygen, water vapor, and the like, in order to prevent oxidation of the rare earth metal and contamination with impurities other than the magnet components.

In order to form a uniform film of the element M over the entire surface or a portion of the surface of the magnet having any one of various shapes, a particularly effective method is a sputtering method of three-dimensionally depositing the metal component M on the surface of the magnet using a plurality of targets or an ion plating method of ionizing the element M and then depositing element ions using the strong adhesive property due to electrostatic attraction.

Furthermore, as a method usable for holding the rare earth-based magnet in a plasma space during the above-described working, at least one magnet may be rotatably held by a linear member or a plate member, or a plurality of magnets may be arranged on a dish-like vessel or mounted in a wire-net cage so that the magnets can be tumbled. Such a holding method is capable of three-dimensionally, uniformly forming the film over the entire surface of the magnet.

FIG. 4 shows the concept of a three-dimensional sputtering apparatus suitable for carrying out the production method of the present invention. In FIG. 4, ring targets 1 and 2 each composed of a metal to be deposited are opposed to each other, and a water-cooled high-frequency coil 3 made of copper is disposed between the targets 1 and 2. Also, an electrode wire 5 is inserted into the cylinder portion of a cylindrical magnet 4, the electrode wire 5 being fixed to a rotational shaft of a motor 6 to rotatably hold the cylindrical magnet 4. In a method usable for a columnar or prismatic magnet having no hole, a plurality of magnet products is mounted in a wire-net cage so that the magnets can be tumbled.

Furthermore, the apparatus has a mechanism capable of reverse sputtering of the cylindrical magnet 4 using a cathode changeover switch turned to side (A). In the reserve sputtering, the magnet 4 is set to a negative potential through the electrode wire 5 to etch the surface of the magnet 4. In a normal sputtering work, the switch is turned to side (B). In the normal sputtering, sputtering deposition is generally performed with no potential applied to the electrode wire 5. In order to control the type of the metal to be deposited and the film quality, sputtering deposition may be performed with the positive bias potential applied to the magnet 4 through the electrode wire 5. In the normal sputtering, a plasma space 7 containing Ar ions and the metal particles and metal ions produced from the targets 1 and 2 is formed, and the metal particles are three-dimensionally sprayed on the surface of the cylindrical magnet 4 from all directions thereof to deposit a film.

When diffusion is not carried out during the deposition, the magnet with the film deposited thereon as described above is transferred to a glove box without contact with air after the sputtering apparatus is returned to the atmospheric pressure, the glove box being connected to the sputtering apparatus. Then, the magnet is placed in a small electric furnace in the glove box and heat-treated therein for diffusing the metal component of the deposited film into the magnet.

Since rare earth metals are generally easily oxidized, a corrosion-resistant metal such as Ni or Al, an inorganic substance, or a water-repellent silane film is preferably formed on the surface of the magnet after the deposition, for preventing rusting in practical use. When the surface of the metal is composed of a metal such as Dy or Tb, deposition of a corrosion-resistance film may be omitted according to applications of the magnet because oxidation of such a metal proceeds more slowly in air than Nd.

### BRIEF DESCRIPTION OF THE DRAWINGS

FIG. 1 shows a Dy element EPMA image (a) of a sample (3) prepared by Dy deposition and then heat treatment according to the present invention, and a Dy element EPMA image (b) of a comparative example sample (1).

FIG. 2 is a graph showing the relations between the Dy content and the coercive force measured using samples of the present invention and comparative example samples.

FIG. 3 is a graph showing the relations between the residual magnetic flux density and the coercive force measured using samples of the present invention and comparative example samples.

FIG. 4 is a schematic drawing showing the periphery of targets in a three-dimensional sputtering apparatus suitably used for a method of the present invention.

FIG. 5 is a graph showing the relations of the coercive force to the Dy and Tb contents measured using samples of the present invention and comparative example samples.

FIG. 6 is a graph showing the relations between the coercive force and the residual magnetic flux density measured using samples of the present invention and comparative example samples.

### EXAMPLES

The present invention will be described in detail below with reference to examples.

### Example 1

An alloy thin leaf having a thickness of about 0.3 mm was formed from an alloy ingot having the composition, Nd_{12.5}Fe_{78.5}Co₁B₈, by a strip casting method. Next, this thin leaf was placed in a vessel, and hydrogen gas of 500 Pa was occluded in the thin leaf at room temperature than then released to form a powder of 0.1 to 0.2 mm in size having no regular shape. Then, the powder was ground with a jet mill to prepare a fine powder of about 3 μm.

Then, 0.05% by mass of calcium stearate was mixed with the fine powder, and the resultant mixture was charged in a mold and molded by pressing in a magnetic field. The resulting molded product was placed in a vacuum furnace and sintered at 1080° C. for 1 hour, and further machined by cutting, boring, cylindrical grinding, and the like to prepare a cylindrical magnet having an outer diameter of 2.4 mm, an inner diameter of 1 mm, a length of 3 mm, and a volume of 11.2 mm³. This magnet was used as comparative example sample (1).

Next, a Dy metal was deposited in a film on the surface of the cylindrical magnet using the three-dimensional sputtering apparatus shown in FIG. 4. In the apparatus, a Dy metal was mounted as each target to deposit films of the Dy metal on both end surfaces and the outer surface of the cylindrical magnet. The Dy metal target used had a purity of 99.9% and had a ring shape having an outer diameter of 80 mm, an inner diameter of 30 mm, and a thickness of 20 mm.

The deposition working was actually carried out according to the following procedures: A tungsten wire having a diameter of 0.3 mm was inserted and set in the cylinder portion of the cylindrical magnet, and the inside of the sputtering apparatus was evacuated to a vacuum of 5×10⁻⁵ Pa. Then, high-purity Ar gas was introduced into the apparatus to keep the inside of the apparatus at 3 Pa. Next, the cathode changeover switch was turned to the side (A), and a RF power of 30 W and a DC power of 2 W were applied to perform reverse sputtering for 5 minutes, for removing oxide films on the surface of the magnet. Then, the changeover switch was turned to the side (B), and a RF power of 60 W and a DC power of 100 W were applied to perform normal sputtering for 10 minutes, thereby forming a Dy film having a thickness of 3 μm.

The resulting magnet with the film deposited thereon was transferred to a glove box without contact with air after the sputtering apparatus was returned to the atmospheric pressure, the glove box being connected to the sputtering apparatus. The magnet was placed in an electric furnace provided in the glove box and heat-treated at 600° C. to 1000° C. for 10 minutes in a first step and at 600° C. for 20 minutes in a second step. Table 1 shows samples (1) to (5) of the present invention produced by the above-described method at various treatment temperatures in the first step. A magnet subjected to film deposition but not subjected to heat treatment was prepared as a comparative example sample (2). In order to prevent oxidation of the magnet during heat treatment, a purified Ar gas was circulated in the glove box to maintain the oxygen content at 2 ppm or less and the dew point at −75° C. or less.

The magnetic properties of each sample were measured with a vibrating sample magnetometer after a pulse magnetization of 4.8 MA/m was applied. Table 1 also shows the magnetic property values of each sample. As a result of ICP analysis of an acid solution of each of the sample (3) of the present invention and the comparative example sample (1), the content of the Dy element in the sample (3) was 0.84% by mass, and the content in the comparative example sample (1) was 0.02% by mass. In particular, the content in the comparative example sample (1) was a measurement error level. Table 1 shows the magnetic properties of the comparative example samples and the samples of the present invention.

TABLE 1

| | Treatment | | | |
|---|---|---|---|---|
| | temperature | | Br | (BH)ₘₐₓ |
| Sample | (° C.) | H_{cj} (MA/m) | (T) | (kJ/m³) |
| Comparative Example (1) | — | 1.04 | 1.44 | 351 |
| Comparative Example (2) | — | 1.03 | 1.43 | 350 |
| This invention (1) | 600 | 1.24 | 1.43 | 363 |
| This invention (2) | 700 | 1.32 | 1.44 | 376 |
| This invention (3) | 800 | 1.36 | 1.44 | 383 |
| This invention (4) | 900 | 1.41 | 1.45 | 384 |
| This invention (5) | 1000 | 1.35 | 1.42 | 365 |

Table 1 indicates that any one of the samples (1) to (5) of the present invention, which were subjected to deposition of the Dy metal and heat treatment, exhibits a higher coercive force than those of the comparative example samples, and the coercive force of each of the samples (1) to (5) exceeds 1.168 (MA/m) calculated from the relational expression H_{cj}=1+0.2×M (=0.84). It is also found that each of the samples (1) to (5) exhibits a high magnetic energy product.

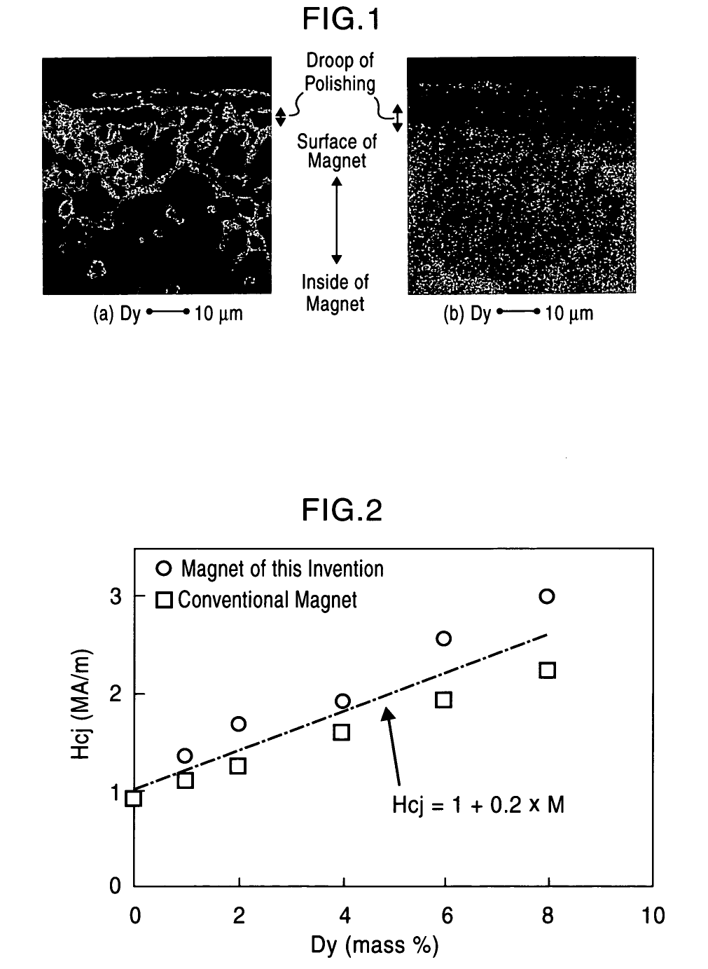

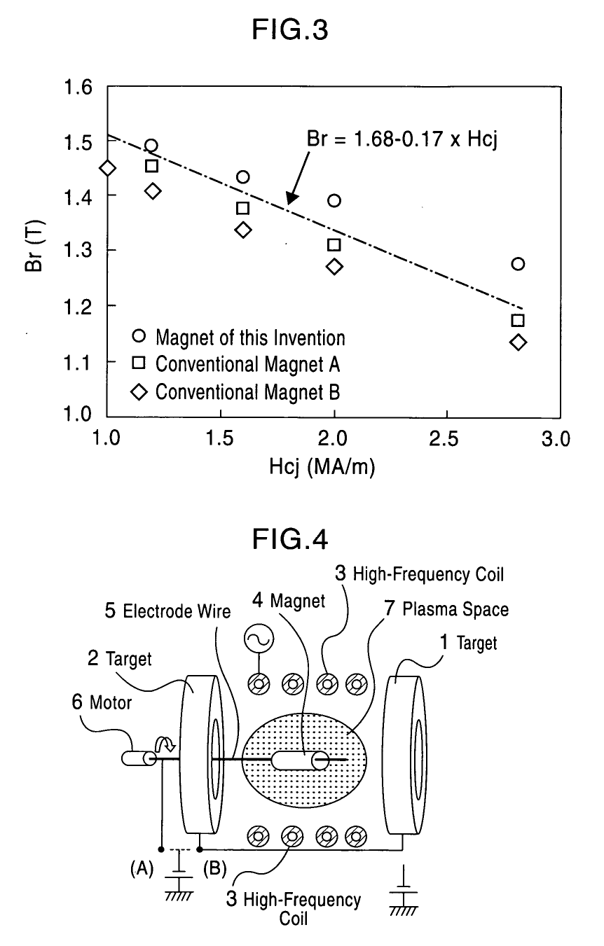

The supposed reason for these results is that the concentration of the rare earth metal distributed by diffusion is higher in a portion directly below the surface of the sintered magnet and on the surface side of a crystal grain boundary below the surface, and thus the occurrence of a reverse magnetic domain can be suppressed, thereby improving the coercive force. Furthermore, in the comparative example sample (2) not subjected to heat treatment, a diffusion layer is not formed, and thus the coercive force is not increased. A Dy element EPMA image of the sample (3) of the present invention is as shown in FIG. 1.

### Example 2

A sintered magnet block having a side length of 24 mm was prepared using an alloy having the same composition Nd_{12.5}Fe_{78.5}Co₁B₈, as in Example 1 as a starting raw material, and a disk-shaped magnet having an outer diameter of 4 mm, a thickness of 1 mm, and a volume of 12.6 mm³ was formed by cutting and grinding with a grindstone and discharge processing. In a three-dimensional sputtering apparatus, a target of each of Dy and Tb metals was mounted, and the magnet was inserted in a tungsten electrode wire coil. The two targets exchanged to deposit metal films on two respective magnets. In a film deposition work, as in Example 1, oxide films of the surface of each magnet were removed by reverse sputtering, and then a RF power of 60 W and a DC power of 200 W were applied to perform normal sputtering for 5 to 50 minutes, thereby forming a film of 2 to 18 μm.

Then, one of the two magnets was placed in an electric furnace in a glove box and heat-treated at 900° C. for 10 minutes and at 600° C. for 20 minutes to form a sample of the present invention. Prepared samples of the present invention included a sample (6) having a Dy film thickness of 2 μm and a Dy content of 0.6% by mass, and samples (7) to (10) having Dy contents of 1.3% by mass, 2.5% by mass, 3.6% by mass, and 5.1% by mass, respectively, according to Dy film thicknesses. With respect to Tb, Tb has substantially the same sputtering rate as that of Dy, and thus a Tb film formed by sputtering for the same time as that for Dy has the same thickness as a Dy film. Therefore, similarly, samples (11) to (15) of the present invention having the respective Tb contents of 0.6% by mass to 5.1% by mass were formed. The contents of Dy and Tb were measured by ICP analysis.

On the other hand, Nd of the composition, Nd_{12.5}Fe_{78.5}Co₁B₈, was partially replaced by Dy to prepare various alloy ingots having different Dy contents. Each the alloy ingots was melted and formed in a thin leaf by a strip casting method. The thin leaf was ground, molded, sintered, and then machined to prepare a magnet having the same dimensions and volume as described above. Samples prepared by replacing with Dy included a comparative example sample (3) having a Dy content of 0.5% by mass and comparative examples samples (4) to (7) having Dy contents of 1.4% by mass, 2.4% by mass, 3.4% by mass, and 5.2% by mass, respectively.

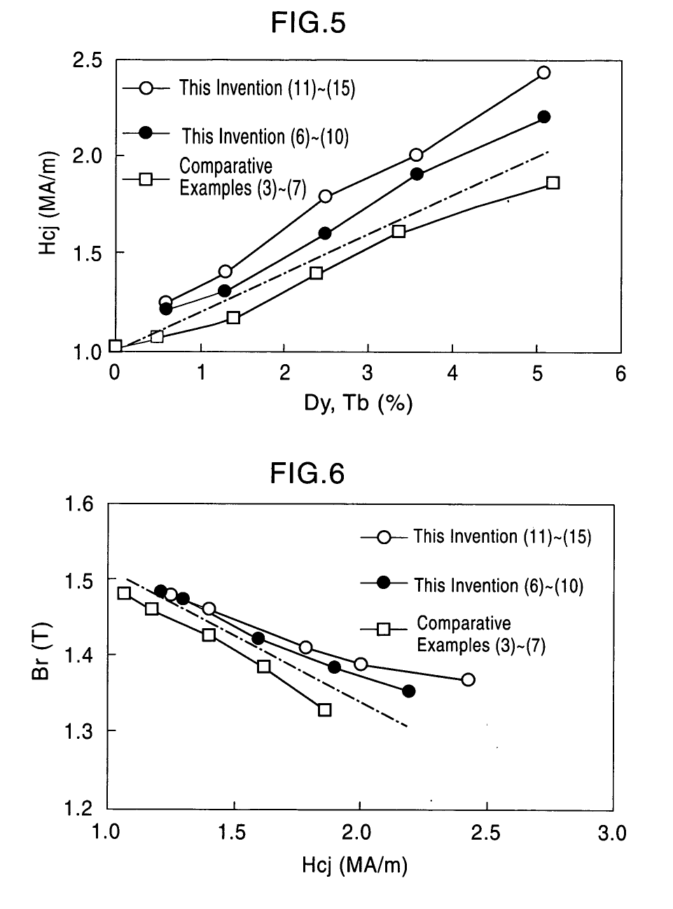

FIG. 5 shows the results of measurement of the coercive force of each magnet sample against the Dy and Tb contents. In this figure, the relational expression, H_{cj}=1+0.2×M (M is the content (% by mass) of Dy or Tb) is shown by a one-dot chain line. FIG. 5 reveals that any one of the samples of the present invention has a higher coercive force than those of the comparative examples samples. It can also be estimated from a different standpoint that in each of the samples of the present invention, the Dy amount for obtaining the same coercive force as that of the comparative example samples produced by a conventional method can be significantly reduced.

The samples (11) and (15) of the present invention were observed by EPMA with respect to the distribution of element Tb in each magnet. As a result, it was found that a Tb layer is present in the surface portion of the magnet, and the element Tb is distributed along crystal grain boundaries to a depth of 50 μm from the surface so that the concentration of the element Tb increases toward the surface side. It was also observed that in the sample (15) of the present invention, a grain boundary phase is thick, and the number of the crystal grains covered with the boundary phase is large, as compared with the sample (11) of the present invention.

FIG. 6 shows the relation between the coercive force and the residual magnetic flux density of each sample. Like in FIG. 5, in FIG. 6, the relational expression, Br=1.68−0.17×H_{cj} is shown by a one-dot chain line. FIG. 6 reveals that the samples of the present invention have a higher residual magnetic flex densities and coercive force than those of the comparative example samples, resulting in improvement in the maximum energy product. This example also shows that the Br is significantly improved as the Dy and Tb contents increase, as compared with the comparative examples.

### Example 3

A disk-shaped magnet having an outer diameter of 4 mm, a thickness of 0.2 mm, 0.4 mm, 1 mm, 2 mm, or 4 mm was prepared from a raw material alloy having the composition Nd₁₂Dy_{0.5}Fe₈₀B_{7.5} by the same process as in Example 2. Next, the magnet was mounted in a three-dimensional sputtering apparatus, and oxide films of the surface of the magnet were removed by reverse sputtering. Then, a RF power of 100 W and a DC power of 120 W were applied to perform normal sputtering for 15 minutes, thereby forming a Dy metal film of 2 μm on the surface of the magnet. Next, each magnet with the film deposited thereon was placed in an electric furnace in a glove box and heat-treated at 800° C. for 30 minutes to prepare samples (16) to (20) of the present invention. Also, a sintered magnet having an outer diameter of 4 mm and a thickness of 1 mm and not subjected to sputtering was prepared as a comparative example sample (8).

The magnetic properties of each sample were measured with a vibrating sample magnetometer, and the total Dy content including the content in the original sintered magnet and the content in the deposited film was measured by ICP analysis. As a result of EPMA observation of a section of the sample (18) of the present invention which had a thickness of 1 mm, it was found that the element Dy is diffused to a depth of about 40μ from the surface along crystal grain boundaries so that the concentration of the element Dy increases toward the surface side.

Table 2 shows the Dy content, the coercive force, and the coercive force(*calculated) calculated by the relational expression H_{cj}=1+0.2×M (M is the content (% by mass) of Dy) of each sample. Table 2 indicates that any one of the samples of the present invention has a higher coercive force than that of the comparative example sample (8). In comparison between the sample (18) of the present invention and the comparative example sample (8) having the same thickness of 1 mm, an about 45% increase in the coercive force is made by an increase of only 0.6% by mass in the Dy content, and such a high coercive force cannot be obtained by a conventional sintered magnet having a Dy content of 1.8% by mass. Any one of the samples of the present invention exhibits a higher coercive force than the force^{(*calculated)} calculated by the relational expression.

TABLE 2

| | Dy content | | H_{cj}⁽*^{calculated}) |
|---|---|---|---|
| Sample | (%) | H_{cj} (MA/m) | (MA/m) |
| Comparative Example (8) | 1.2 | 1.18 | 1.24 |
| This invention (16) | 3.3 | 2.03 | 1.67 |
| This invention (17) | 2.4 | 1.77 | 1.48 |
| This invention (18) | 1.8 | 1.53 | 1.36 |
| This invention (19) | 1.6 | 1.48 | 1.32 |
| This invention (20) | 1.5 | 1.41 | 1.30 |

### Example 4

An Nd—Fe—Co—Dy—B quenched powder was hot-pressed and then plastically hot-processed at 800° C. to prepare an anisotropic magnet having an outer diameter of 10 mm, an inner diameter of 2 mm, a length of 6 mm, and a volume of 452 mm³ as a comparative example sample (9). Another sample prepared by the same method was attached to a rotational holder in an arc-discharge-type ion plating apparatus manufactured by Shinko Seiki Co., Ltd., and the inside of the apparatus was evacuated to a vacuum of 1×10⁻⁴ Pa. Then, a high-purity Ar gas was introduced into the apparatus to maintain the inside at 2 Pa. A voltage of −500 V was applied to the sample which was rotated at 20 turns/min, and Dy ions were generated by melting evaporation with an electron gun, a thermal electron emitting electrode, and an ionization electrode. The generated Dy ions were attached to the sample installed directly above a melting crucible for 20 minutes. Next, the sample was placed in a small electric furnace in a glove box and then heat-treated at 800° C. for 60 minutes to prepare a sample (21) of the present invention.

The Dy content of each sample was determined by ICP analysis. The distribution of element Dy was observed with EPMA. As a result, in the comparative example sample (9), the element Dy was distributed over the entire region of the magnet, and a high Dy distribution in a crystal grin boundary could not be clearly observed. On the other hand, in the sample (21) of the present invention, a Dy layer having a thickness of 4 μm was observed on the surface of the magnet. It was also found that element Dy was distributed to a depth of about 40 μm from the surface along crystal grain boundaries so that the concentration of the Dy element increases toward the surface side.

Table 3 shows the results of the Dy content and the magnetic properties of each sample. Table 3 indicates that the sample of the present invention has an extremely high coercive force even at a small Dy content, and exhibits magnetic properties superior to the Br^{(*calculated)} and H_{cj}^{(*calculated)} calculated by the relational expressions, Br≧1.68−0.16×H_{cj} and H_{cj}=1+0.2×M (M is the Dy content (% by mass)).

TABLE 3

| | Dy | | | | |
|---|---|---|---|---|---|
| | content | H_{cj} | Br | H_{cj}⁽*^{calculated)} | Br⁽*^{calculated)} |
| Sample | (%) | (MA/m) | (T) | (MA/m) | (T) |
| Comparative | 1.1 | 1.18 | 1.46 | 1.22 | 1.49 |
| Example (9) | | | | | |
| This | 3.2 | 1.75 | 1.44 | 1.64 | 1.40 |
| invention (21) | | | | | |

### Example 5

A raw material alloy having the composition, Nd₁₀Pr₂Fe_{77.5}Co₃B_{7.5}, was melted, ground, molded, and then sintered to prepare a plate-like magnet having a length of 20 mm, a width of 60 mm, a thickness of 2 mm, and a volume of 2400 mm³. The resultant magnet was placed on a SUS substrate in a sputtering apparatus L-250S manufactured by Anelva Co., Ltd., and an alloy target containing 80% by mass of Tb and 20% by mass of Co, which was fixed to a SUS304 back plate, was placed above the magnet.

The inside of the apparatus was evacuated, and then high-purity Ar gas was introduced into the apparatus to maintain the pressure at 5 Pa. In the state in which the SUS substrate was heated to about 550° C., reverse sputtering was performed to remove oxide films from the surface of the magnet. In this example, heating of the substrate and film deposition were simultaneously performed using an increase in temperature of the magnet sample during the deposition. As a result of starting of sputtering with a RF power and a Dc power increased to 150 W and 600 W, respectively, red-heating of the magnet sample was observed. It was estimated from the color that the temperature reached about 800° C. In the state in which the substrate and the sample were heated, film deposition was performed for 30 minutes, and then sputtering was stopped. Then, the sample was turned over, and deposition was performed for 30 minutes under the same conditions as described above to prepare a sample (22) of the present invention.

As a result of EPMA observation of the sample, a Tb—Co layer of about 20 μm was observed on the surface of the magnet. It was also found that Tb and Co elements are distributed to a depth of 80 μm from the surface along crystal grain boundaries so that the contents of these elements increase toward the surface side. As a result of ICP analysis, the Tb content in the magnet was 2.7% by mass. Therefore, another alloy having a finely controlled Co content, a Tb content of 2.4% by mass, and the same Nd—Pr ratio as in the starting alloy used was melted and formed in a magnet as a comparative example sample (10) having the same dimensions as described above. As a result of EPMA observation of the comparative example sample (10), Tb and Co elements were substantially uniformly distributed over the entire region of the magnet, and a difference in Tb content between a crystal grain boundary and a main phase was not easily observed in an image with a magnification of ×2000.

Each of the samples was cut into pieces, and three pieces were stacked and measured for magnetism using a BH tracer. As a result, H_{cj} of the comparative example sample (10) was 1.47 MA/m, but H_{cj} of the sample (22) of the present invention was 1.88 MA/m. Therefore, the sample (22) exhibits a higher coercive force at the same Tb content, and the coercive forces is suitable for high-resistant automobile applications. In this example, it was found that even when deposition and diffusion treatment are performed by the same process, the present invention has an effect. When a sample of the present invention was subjected to a humidity test at 60° C. and 90% RH, the corrosion resistance was improved. It was estimated that the diffusion of Co element into the crystal grain boundaries in the magnet has a desirable effect on the improvement in corrosion resistance.

### REFERENCE NUMERALS

1, 2: metal target

3: water-cooled high-frequency coil

4: cylindrical magnet

5: electrode wire

6: motor

7: plasma space

1. A rare earth-iron-boron based magnet comprising a crystal grain boundary layer enriched in element M (M is at least one rare earth element selected from Pr, Dy, Tb, and Ho) by diffusion of the element M from the surface of the magnet having a rare earth-rich grain boundary layer disposed between main crystals and reaction of the element M with the rare earth-rich phase, wherein the coercive force H_{cj} and the content of the element M in the entire of the magnet satisfy the following equation:
H_{cj}≧1+0.2×M (wherein 0.05≦M≦10)
Wherein H_{cj} is the coercive force (unit: MA/m), and M is the content of the element M in the entire magnet (% by mass).

2. The rare earth-iron-boron based magnet according to claim 1, wherein the residual magnetic flux density Br and the coercive force H_{cj} satisfy the following equation:
Br≧1.68−0.17×H_{cj}
wherein Br is the residual magnetic flux density (unit: T).

3. The rare earth-iron-boron based magnet according to claim 1, wherein the magnet is produced by powder molding and sintering or by powder molding and hot plastic processing, the grain boundary layer rich in the rare earth element is disposed between main crystals.

4. A method for producing a rare earth-iron-boron based magnet according to claim 1, the method comprising physically spraying a steam of fine particles of element M (M is at least one rare earth element selected from Pr, Dy, Tb, and Ho) or an alloy containing the element M onto the entire surface or a portion of the surface of a magnet supported in a reduced pressure vessel to deposit a film of the element M, and diffusing and penetrating the element M into the magnet from the surface thereof, the magnet having the rare earth-rich grain boundary layer disposed between main crystals, so that the element M reaches at least a depth corresponding to the radius of the crystal grains exposed on the outermost surface of the magnet, thereby forming a crystal grain boundary layer enriched in the element M by reaction with the rare earth-rich phase.

5. The method for producing a rare each-iron-boron based magnet according to claim 4, wherein the crystal grain boundary layer is enriched in the element M so that the concentration of the element M toward the surface side of the magnet.
